(19) United States
(12) Patent Application Publication
(10) Pub. No.: US 2002/0034684 A1
(43) Pub. Date: Mar. 21, 2002

(54) Separator for lead storage batteries

(75) Inventor: Frank Muller-Rinke, Hildesheim (DE)

Correspondence Address: IP Department, Schnader Harrison Segal & Lewis, 36th Floor, 1600 Market Street, Philadelphia, PA, 19103, US

(73) Assignee: VB Autobatterie GmbH

(21) Appl. No.: 09/941,339

(22) Filed: Aug. 29, 2001

(30) Foreign Application Priority Data
Sep. 15, 2000 (DE) DE 200 15 963.1

(51) Int. Cl. H01M 2/18; H01M 10/06

(52) U.S. Cl. 429/143; 429/242

(57) ABSTRACT

A separator for lead storage batteries is formed from a strip material, having main ribs arranged at regular intervals on the base sheet of the separator as spacers with respect to the positive electrode and reinforcing ribs which lie close together and are of a lower height than the main ribs arranged in the region which covers the lateral electrode edge. In the region of the reinforcing ribs, an additional rib which is of the same height as the main ribs bears against the lateral edge of the positive electrode and may be arranged symmetrically with respect to the main ribs, is provided at each separator edge, parallel to the main ribs.

### FIELD OF THE INVENTION

This invention relates to a separator for lead storage batteries.

### BACKGROUND

Separators are used in batteries to separate the electrode plates of opposite polarity from one another, so that only electrolyte forms the conductive path between the two plates. In lead storage batteries, the typical separator is a porous diaphragm with parallel-running ribs on one surface. The ribs normally bear against the positive electrode. The flat side of the separator usually faces the negative electrode.

EP 899 801 A1 discloses a separator which is folded around an electrode in the form of a pocket and on one side has main ribs which are arranged at regular intervals and on the other side, in the region of the electrode edge, has a multiplicity of ribs which lie close together and are of a lower height, leading to reinforcement of the edge region. The objective is to prevent, particularly in the case of expanded metal grids, burrs on the open cut edges of the grid webs from puncturing the separator material.

It would accordingly be advantageous to provide a means of further improving the resistance of the separator to punctures at the side edges of the electrode.

### SUMMARY OF THE INVENTION

This invention relates to a separator for a lead storage battery having a positive electrode with lateral edge portions including a strip of material forming a base sheet, a plurality of main ribs arranged at regular intervals on the base sheet and adapted to space the base sheet from the positive electrode, a plurality of reinforcing ribs arranged on the base sheet close together and lower in height than the main ribs, and located in the region which covers the lateral electrode edge portions, and an additional rib arranged on the base sheet at each edge portion of the separator substantially parallel to the main ribs in the region of the reinforcing ribs, which ribs are of substantially the same height as the main ribs and bear against the lateral edge portions of the positive electrode.

### BRIEF DESCRIPTION OF THE DRAWINGS

The separator according to the invention is explained in more detail below with reference to the Figures.

FIG. 1 shows the separator strip material behind an expanded metal grid.

FIG. 2 shows a cross section of the separator strip material from FIG. 1.

FIG. 3 shows a partial enlargement of the cross section through the separator of FIG. 2.

### DETAILED DESCRIPTION

It will be appreciated that the following description is intended to refer to specific embodiments of the invention selected for illustration in the drawings and is not intended to define or limit the invention, other than in the appended claims.

This invention relates to a separator for lead storage batteries which is formed from a strip material, main ribs, which are arranged at regular intervals on the base sheet of the separator, being provided as spacers with respect to the positive electrode, and reinforcing ribs, which lie close together and are of a lower height than the main ribs, being arranged in the region which covers the lateral electrode edge.

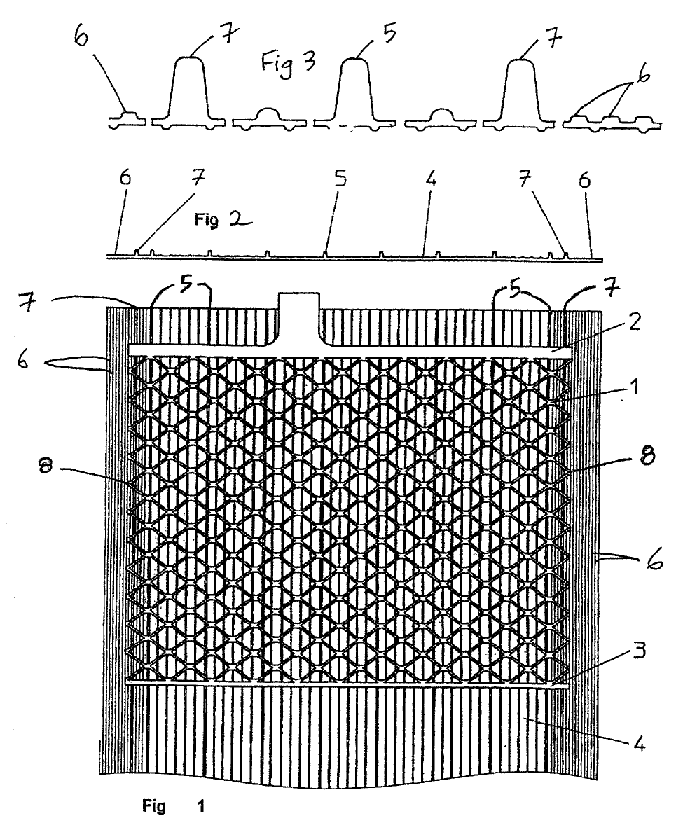

Turning now to the drawings in general and FIG. 1 in particular, the electrode plate 1, which is produced in a manner known per se from expanded metal, has an upper edge closure with a plate lug 2 and a lower closure 3, The material is cut off at the lateral edges 8. As a result, burrs are formed, which can puncture the thin separator material.

Also, referring to FIGS. 2 and 3, the separator 4 illustrated behind the expanded metal has main ribs 5 arranged at substantially regular intervals and reinforcing ribs 6 arranged close together and are of a significantly lower height than the main ribs 5 in the region which covers the edges 8 of the electrode 1. By way of example, in conventional separators, the base sheet has a thickness of approximately 0.15-0.25 mm, the main ribs 5 have a height of approximately 0.45-1.75 mm and the reinforcing ribs have a height of approximately 0.1-0.2 mm.

According to the invention, in the region of the reinforcing ribs 6, at each edge 9 of the separator an additional rib 7, which is of the same height as the main ribs 5 and bears directly against the lateral edge 8 of the positive electrode 1, is provided substantially parallel to the main ribs. These additional ribs 7 may be arranged in both edge 8 regions, in particular, symmetrically with respect to the main ribs 5. By way of example, given a conventional electrode width of approximately 144 mm, the distance between the additional ribs 7 lies in the range from approximately 140 mm to 144 mm. The additional ribs 7 are at a distance of approximately 5 mm to 7 mm from the adjacent main rib 5. The main ribs 5 are spaced apart from one another at intervals of approximately 14 mm. The additional rib 7 according to the invention, which can easily be produced during the extrusion process used for the separator strip material, prevents accumulation of material in the edge region. The resistance of the separator to oxidation during installation of positive electrode plates is improved, since the additional rib 7 according to the invention is arranged at the edge 8 of the electrode grid 1 and, therefore, the edge 8 of the grid is not resting on the base sheet of the separator.

What is claimed:

1. A separator for a lead storage battery having a positive electrode with lateral edge portions comprising:
a strip of material forming a base sheet;
a plurality of main ribs arranged at regular intervals on the base sheet and adapted to space the base sheet from the positive electrode;
a plurality of reinforcing ribs arranged on the base sheet close together and lower in height than the main ribs, and located in the region which covers the lateral electrode edge portions; and
an additional rib arranged on the base sheet at each lateral edge portion of the separator substantially parallel to the main ribs in the region of the reinforcing ribs, which ribs are of substantially the same height as the main ribs and bear against the lateral edge portions of the positive electrode.

2. The separator as claimed in claim 1, wherein the additional ribs in both lateral edge portions are arranged symmetrically with respect to the main ribs.

3. The separator as claimed in claim 1, wherein all of the ribs are integral with the base sheet.

4. The separator as claimed in claim 1, wherein the positive electrode comprises an expanded metal grid and the lateral edge portions have open cut edges.

5. The separator as claimed in claim 1, wherein the base sheet has a thickness of approximately 0.15-0.25 mm.

6. The separator as claimed in claim 1, wherein the main ribs and the additional ribs have a height of approximately 0.45-1.75 mm.

7. The separator as claimed in claim 1, wherein the reinforcing ribs have a height of approximately 0.1-0.2 mm.

8. A lead storage battery comprising:
a container;
a positive electrode positioned in the container and having lateral edge portions;
a negative electrode positioned in the container;
an electrolyte positioned in the container; and
a separator positioned between the positive and negative electrodes, the separator comprising: 1) a strip of material forming a base sheet, 2) a plurality of main ribs arranged on the base sheet, the main ribs being spaced apart at substantially regular intervals and being substantially parallel to one another, 3) a plurality of reinforcing ribs arranged on the base sheet in the area of the lateral edge portions, the reinforcing ribs having a lower height than the main ribs and being substantially parallel to one another, and 4) an additional rib arranged on the base sheet and in contact with each lateral edge portion, the additional ribs having substantially the same height as the main ribs and being substantially parallel to the main ribs.

9. The battery as claimed in claim 8, wherein the additional ribs in both lateral edge portions are arranged symmetrically with respect to the main ribs.

10. The battery as claimed in claim 8, wherein all of the ribs are integral with the base sheet.

11. The battery as claimed in claim 8, wherein the positive electrode comprises an expanded metal grid and the lateral edge portions have open cut edges.

12. The battery as claimed in claim 8, wherein the base sheet has a thickness of approximately 0.15-0.25 mm.

13. The battery as claimed in claim 8, wherein the main ribs and the additional ribs have a height of approximately 0.45-1.75 mm.

14. The battery as claimed in claim 8, wherein the reinforcing ribs have a height of approximately 0.1-0.2 mm.
